(19) United States
(12) Patent Application Publication
(10) Pub. No.: US 2021/0304188 A1
(43) Pub. Date: Sep. 30, 2021

(54) USER-INTERACTIVE DIGITAL SIGNAGE APPARATUS THAT DISPLAYS CONTENTS ASSOCIATED WITH PREPAID CARD

(71) Applicant: TOSHIBA TEC KABUSHIKI KAISHA, Tokyo (JP)

(72) Inventor: Fraser SNOWDON, Epping (AU)

(21) Appl. No.: 16/832,340

(22) Filed: Mar. 27, 2020

(51) Int. Cl. G06Q 20/34; G06Q 30/02; G06Q 30/06; G06K 7/00; G06F 3/041

(52) U.S. Cl. CPC G06Q 20/342; G06Q 20/3433; G06Q 20/3567; G06F 3/0412; G06Q 30/0219; G06Q 30/0641; G06K 7/0056; G06Q 30/0229

(57) ABSTRACT

A user-interactive digital signage apparatus includes a signage housing, a touch panel display, a card reader, and a controller. The card reader is configured to read card information from a prepaid card presented by a user at the retail space. The controller is configured to obtain map image data for a map image of the retail space using the card information, the map image data including information on one or more affiliated stores that are affiliated with the prepaid card among a plurality of stores in the retail space. The controller is configured to control the touch panel display to display a user-interactive retail space map including one or more map elements corresponding to at least a part of the one or more affiliated stores, in an emphasized display manner with respect to one or more map elements corresponding to one or more non-affiliated stores in the retail space.

### BACKGROUND

A variety of prepaid cards (e.g., gift cards) are in wide use around the world. One type of a prepaid card is configured with a card medium and a predetermined amount of monetary values is preloaded therein. Some type of prepaid cards may be available only in certain affiliated stores. For example, a prepaid card issued by an entity that runs a group of restaurants may be available only in the restaurants. In another example, a prepaid card issued by a company group may be available only in stores of companies in the company group. In addition, a user of a prepaid card usually cannot see the balance of the prepaid card, just by looking at the card medium.

In another field of technology, a user-interactive digital signage apparatus is widely used in various kinds of venues, such as shopping malls, airports, convention centers, and so on. Such a user-interactive digital signage apparatus displays various kinds of information useful at the venues, such as guidance information (e.g., a map), advertisement, announcements related to the venue. Users can manipulate the user-interactive digital signage apparatus using, for example, a touch panel display thereof, to obtain necessary information. It would be desirable for such a user-interactive digital signage apparatus to display contents associated with one or more prepaid cards presented by a user at the user-interactive digital signage apparatus.

### SUMMARY

Various embodiments of the present disclosure provide a user-interactive digital signage apparatus that displays contents associated with one or more prepaid cards presented by a user at the user-interactive digital signage apparatus. A user-interactive digital signage apparatus includes a signage housing, a touch panel display, a card reader, and a controller. The signage housing is formed to be placeable at a retail space. The touch panel display is mounted in the signage housing. The card reader is mounted on the signage housing and configured to read card information from a prepaid card presented by a user at the retail space.

In some embodiments, the controller is configured to obtain map image data for a map image of the retail space using the card information, the map image data including information on one or more affiliated stores that are affiliated with the prepaid card among a plurality of stores in the retail space. The controller is configured to control the touch panel display to display a user-interactive retail space map including one or more map elements corresponding to at least a part of the one or more affiliated stores, in an emphasized display manner with respect to one or more map elements corresponding to one or more non-affiliated stores in the retail space.

In some embodiments, the user-interactive digital signage apparatus further includes a communication interface, and the controller is further configured to control the communication interface to transmit the card information to a server and then receive the map image data from the server. In some embodiments, the communication interface is configured to receive balance data indicating a balance of the prepaid card, and the controller is further configured to control the touch panel display to display balance information corresponding to the balance data.

In some embodiments, a balance of the prepaid card is obtainable from the card information read by the card reader, and the at least a part of the one or more affiliated stores is a part of the one or more affiliated stores that are affiliated with the prepaid card, each of the part of the one or more affiliated stores having at least one kind of merchandise priced less than the balance of the prepaid card.

In some embodiments, the controller is further configured to obtain promotion data indicating one or more kinds of promoted merchandise associated with at least one of the one or more affiliated stores, and control the touch panel display to display promotion information corresponding to the promotion data. In some embodiments, the controller is further configured to detect a user touch operation on a map element in the user-interactive retail space map to select one of the one or more affiliated stores, and the promotion data indicates one or more kinds of promoted merchandise associated with the selected one of the one or more affiliated stores. In some embodiments, the controller is further configured to display the promotion information in a display element overlaid on the user-interactive retail space map.

In some embodiments, a balance of the prepaid card is obtainable from the card information read by the card reader, and the one or more kinds of promoted merchandise are selected from merchandise that is priced less than the balance, among merchandise registered for sale in the one or more affiliated stores.

In some embodiments, a balance of the prepaid card is obtainable from the card information read by the card reader, and the one or more kinds of promoted merchandise are selected from merchandise that is priced less than the balance by a predetermined amount or less, among merchandise registered for sale in the one or more affiliated stores.

In some embodiments, the card reader is configured to electro-magnetically read the card information from the prepaid card.

In some embodiments, the controller is configured to obtain first card information from a first prepaid card read by the card reader and second card information from a second prepaid card read by the card reader, and obtain map image data for a map image of the retail space using the first and second card information, the map image data including information on one or more affiliated stores that are affiliated with the first and second prepaid cards among a plurality of stores in the retail space. The controller is further configured to control the touch panel display to display a user-interactive retail space map including one or more map elements corresponding to at least a part of the one or more affiliated stores, in an emphasized display manner with respect to one or more map elements corresponding to one or more non-affiliated stores in the retail space.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 schematically illustrates an example of a structure of a store operation system according to some embodiments;

FIG. 2 schematically illustrates an example of a front view of a user-interactive digital signage apparatus according to some embodiments;

FIG. 3 is a block diagram illustrating an example of hardware components of a server apparatus according to some embodiments;

FIG. 4 schematically illustrates an example of a data structure of tables;

FIG. 5 is a block diagram illustrating an example of hardware components of a user-interactive digital signage apparatus according to some embodiments;

FIG. 6 is a block diagram illustrating an example of functional components of a server apparatus according to some embodiments;

FIG. 7 is a block diagram illustrating an example of functional components of a user-interactive digital signage apparatus according to some embodiments;

FIG. 8 is a flowchart showing a process performed by a server apparatus and a user-interactive digital signage apparatus according to some embodiments; and

FIGS. 9A-9D illustrate an example of a user-interactive map displayed by a user-interactive digital signage apparatus according to some embodiments.

### DETAILED DESCRIPTION

A claimed solution rooted in computer technology overcomes problems specifically arising in the realm of computer technology, in particular, in the fields of digital signage apparatuses. In various implementations, a user-interactive digital signage apparatus that displays contents associated with one or more prepaid cards presented by a user at the user-interactive digital signage apparatus is provided. According to the user-interactive digital signage apparatus, contents associated with the one or more prepaid cards presented by the user can be delivered to and then displayed on the user-interactive digital signage apparatus quickly so that the user can obtain desired information with less stress.

In this disclosure, a “user-interactive” digital signage apparatus refers to involvement of actions or inputs of a user in presentation of information by the digital signage apparatus. The user involvement may include a user involvement in response to presentation of information by the digital signage apparatus and/or presentation of information by the digital signage apparatus in response to a user involvement. The “contents” may include a map of a retail space showing locations of stores in the retail space and/or a list of the stores in the retail space.

“Prepaid card” refers to a tangible and/or intangible prepaid card medium that has a monetary value that can be used for purchase. The tangible prepaid card medium may be a card medium configured in a similar manner as conventional credit cards, which stores data electromagnetically in a magnetic stripe and/or a chip embedded in the card medium. The intangible prepaid card may be a digital payment platform (e.g., Apple pay, Google pay, Alipay, etc.) that can function with a portable or hand-held digital device such as smartphones, smartwatches, and tablets. A representative image (e.g., a card image and/or a code symbol) of the intangible prepaid card may be displayed on the digital device and data necessary for transaction may be obtained wirelessly (e.g., electronically or optically) from the digital device. Depending on a specific implementation, the prepaid card may or may not be reloadable.

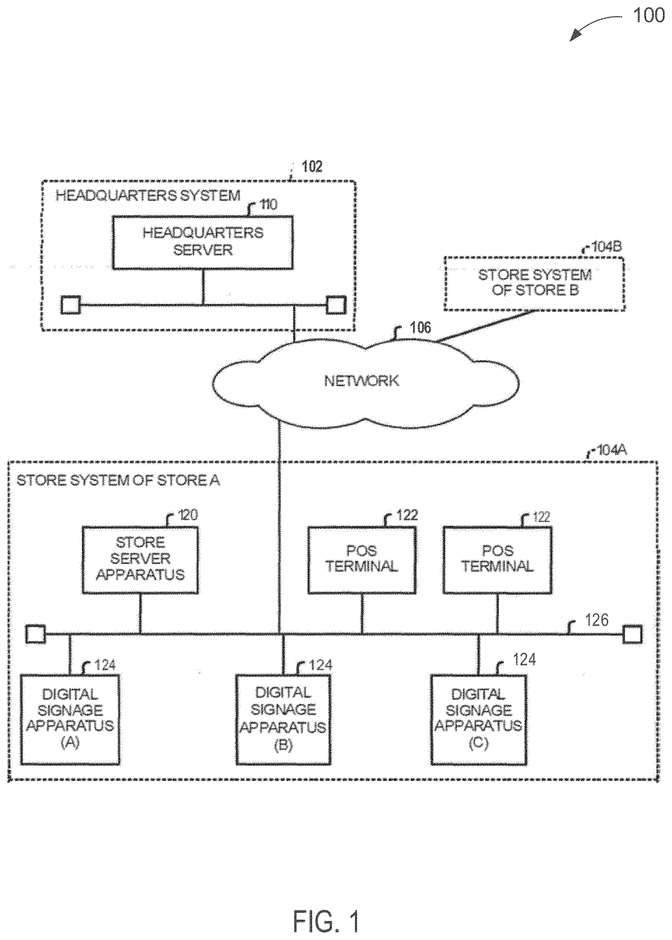

FIG. 1 schematically illustrates an example of a structure of a store operation system 100 according to some embodiments. In FIG. 1, the store operation system 100 comprises a headquarters system 102 and a plurality of store systems 104A and 104B (two store systems in FIG. 1, and representatively referred to as a store system 104 hereinafter). The headquarters system 102 and the store systems 104A and 104B are connected through a public communication network such as an Internet and the like, a network 106 such as a VPN (virtual private network) and the like, or a connecting apparatus such as a router and the like (not shown).

The headquarters system 102 is provided in a headquarters that collectively manages each store and comprises a headquarters server 110, a printer, a personal computer, and the like (not shown in the figures).

The store system 104 is provided in a retail venue, such as a shopping mall, where a plurality of stores are located. The store system 104 comprises a store server apparatus 120, a plurality of POS (point of sales) terminals 122 (two terminals in FIG. 1), and a plurality of digital signage apparatuses 124 (three digital signage apparatuses in FIG. 1), all of which are connected through a communication network 126 such as a LAN (local area network) and the like.

The store server apparatus 120 is an information processing apparatus, provided in an office and the like of the retail venue, which collectively manages all of the store system 104 as an upper level apparatus. The store server apparatus 120 carries out a sales management based on sales data sent from the POS terminals 122. In addition, the store server apparatus 120 distributes to one or more of the digital signage apparatuses 124 through the communication network 126 content such as an animation or a still picture and the like which is displayed on the one or more digital signage apparatus 124 as guidance information for customers.

The POS terminal 122 is an information processing terminal, provided in a checkout counter in a store, which carries out reception/transmission of commodity information (commodity code, commodity name, unit price, and the like) with the store server apparatus 120 through the communication network 126 to execute registration and settlement of commodity purchased by customers.

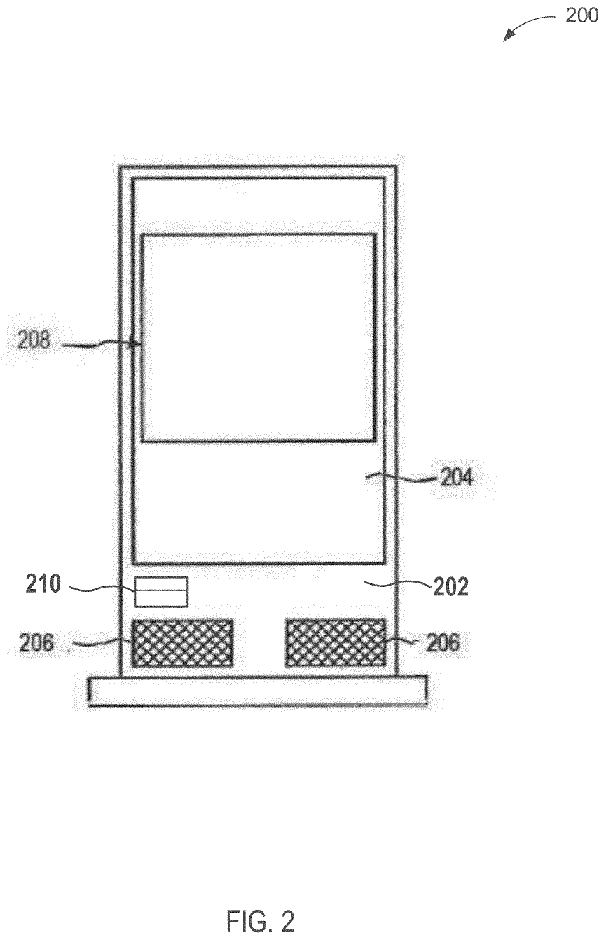

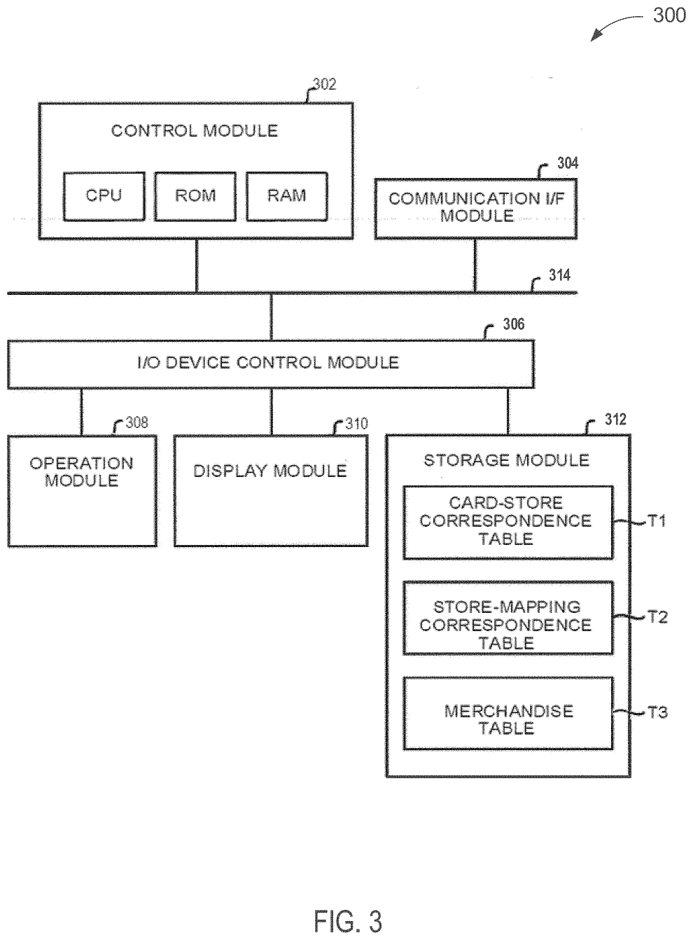

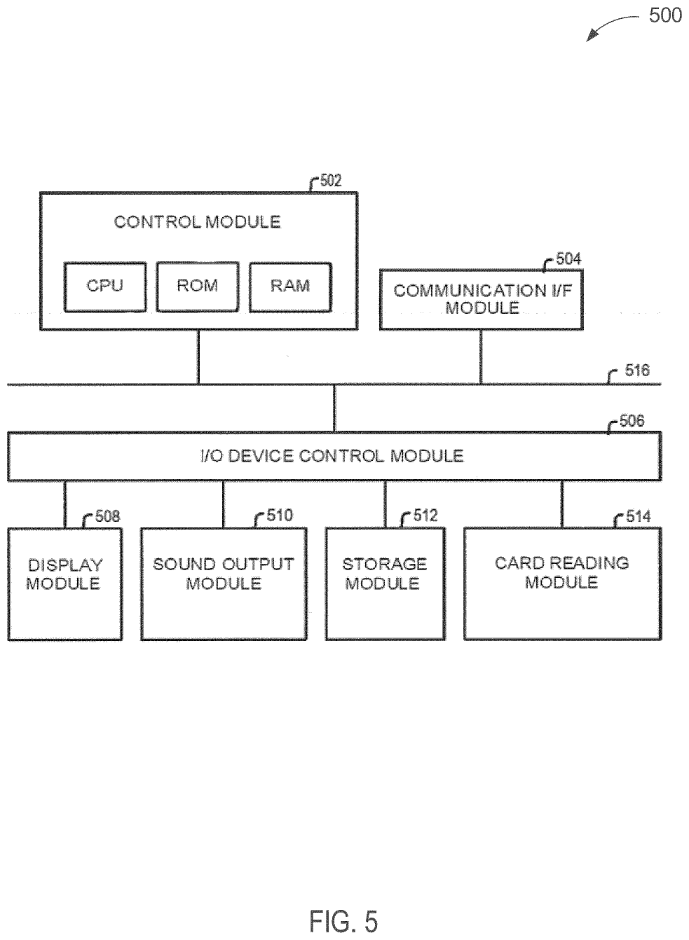

The digital signage apparatus 124 is an apparatus configured to digitally present information such that a user can interact with the presented information. Hereinafter, the digital signage apparatus 124 may be referred to as a user-interactive digital signage apparatus. In some embodiments, the digital signage apparatus 124 is provided in a retail space (e.g., a shopping floor, an entrance, and the like) of the retail venue and displays a digital image of the content received from the store server apparatus 120 through the communication network 120 on a display such as display module 204 (see FIG. 2) and/or a display module 310 (see FIG. 3). The image may include various kinds of information. More specifically, the information may include guidance information for customers, such as a map of the retail space and a route to a specific place (e.g., a specific store in a mall) in the retail space. In a specific implementation, the guidance information may include a retail space map (e.g., floor map) of a retail venue. The digital signage apparatus 124 may also generates an acoustic output, such as a voice guidance, from a sound output module, such as a sound output module 206 (see FIG. 2) and/or a sound output module 510 (see FIG. 5).

FIG. 2 schematically illustrates an example of a front view of a user-interactive digital signage apparatus 200 according to some embodiments. In some embodiments, the user-interactive digital signage apparatus 200 illustrated in FIG. 2 may correspond to the digital signage apparatus 124 illustrated in FIG. 1. In FIG. 2, the user-interactive digital signage apparatus 200 comprises a signage housing 202, a display module 204, a sound output module 206, and a card reading module 210.

The signage housing 202 is a housing of the user-interactive digital signage apparatus 200. The signage housing 202 is configured to be placeable at a retail space. In a specific implementation, the signage housing 202 may include a stand (not shown) configured to enable the user-interactive digital signage apparatus 200 to stand and/or a caster (not shown) configured to enable movement of the user-interactive digital signage apparatus 200 at the retail space. The display module 204, the sound output module 206, and the card reading module 210 are mounted in the signage housing 202.

The display module 204 displays an image 208 showing various kinds of information such as guidance information and the like based on received content. In a specific implementation, the display module 204 is configured with a liquid crystal display or an OLED (organic light-emitting diode), and the like. In a specific implementation, the guidance information may include a retail space map (e.g., floor map) of a retail venue.

The sound output module 206 outputs various kinds of sounds such as a BGM (background music), machine-generated voice, human voice (e.g., guidance information and advertisement), and the like, based on received content. In a specific implementation, the sound output module 206 is configured with a speaker and the like.

The card reading module 210 is a reading module configured to read card information from a prepaid card presented by a user at the retail space. Depending on a card category of the prepaid card, the prepaid card may be affiliated with one or more stores in a retail venue, that is, the prepaid card may be used for purchase in the one or more stores. In some embodiments, the card reading module 210 is configured to electromagnetically read the card information from a tangible prepaid card medium from a data storage medium of the tangible card such as a magnetic stripe and a chip. In a specific implementation, a user may swipe a tangible prepaid card medium such that card information is read by the card reading module 210. In some embodiments, the card reading module 210 is configured to optically read the card information from a tangible prepaid card or a representative image of an intangible prepaid card (e.g., e-prepaid card) that is displayed on a hand-held device such as a cell phone or a tablet. In a specific implementation, the card reading module 210 may be a code reader or a camera. In a specific implementation, the representative image may include a one-dimensional code symbol (e.g., barcode) and/or a two-dimensional code symbol (e.g., QR Code®).

In some embodiments, the card information may include a card identifier (ID) of a prepaid card, which may, for example, include 16-digit number. In some embodiments, the card information may include a user identifier (ID) of a user associated with the prepaid card. In some embodiments, the card information may include a value indicating a balance of the prepaid card.

In some embodiments, the user-interactive digital signage apparatus 200 may further include a printing apparatus (printer) configured to perform printing of various materials, such as tickets, coupons, receipts, and the like, and/or a short-distance communication module configured to carry out a short-distance communication with devices, such as a cell phone held by a customer.

FIG. 3 is a block diagram illustrating an example of hardware components of a server apparatus 300 according to some embodiments. In some embodiments, the server apparatus 300 illustrated in FIG. 3 corresponds to the store server apparatus 120 in FIG. 1.

The server apparatus 300 is a hardware structure utilizing an ordinary computer and, for instance, includes a control module 302, a communication interface (I/F) module 304, and an I/O (input/output) device control module 306, all of which are connected through a bus line 314. The control module 302 comprises a CPU (central processing unit), a ROM (read only memory), a RAM (random access memory) and the like. The control module 302 is a control module configured to control operations of the sever apparatus 300. For example, the control module 302 controls the communication I/F module 304 to transmit data and process data received by the communication I/F module 304. In FIG. 3, the control module 302 is connected to an operation module 314, a display module 310, and a storage module 312, and controls operations thereof.

The operation module 314 is an operation module configured to detect an user operation thereon. The display module 310 is a display module configured to display information thereon. In some embodiments, a touch panel display is configured with the operation module 314 and the display module 310.

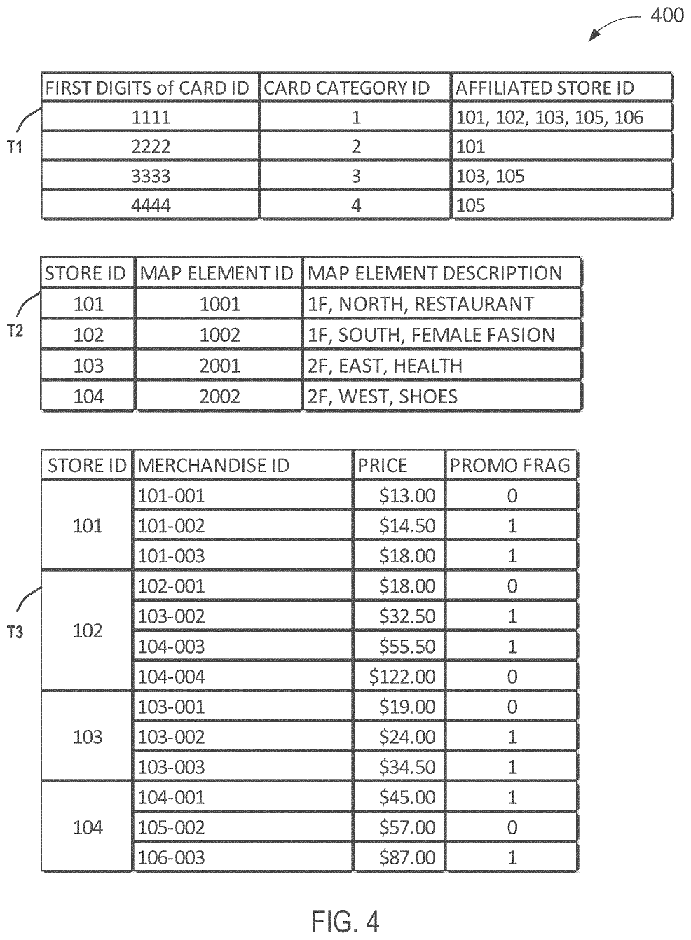

The storage module 312 is a data storage module and may be implemented with a hardware device (HDD: hard disk drive) or an SSD (solid state drive) device and the like. The storage module 312 stores various kinds of information such as a card-store correspondence table T1, a store-mapping correspondence table T2, and a merchandise table T3, which are described below with reference to FIG. 4.

FIG. 4 schematically illustrates an example 400 of a data structure of tables. The tables illustrated in FIG. 4 include a card-store correspondence table T1, a store-mapping correspondence table T2, and a merchandise table T3.

The card-store correspondence table T1 is a table indicating a correspondence among first digits of a card identifier (ID), a card category identifier (ID), and an affiliated store identifier (ID) of each of one or more affiliated stores located in a retail venue. In a specific implementation, a first four digits of a card ID represents a card category, and thus each card ID is associated with one card category ID. In addition, each card category ID is associated with one or more affiliated store IDs. For example, a card category ID is associated with a particular company group, and stores of companies in the particular company group may be associated with the card category ID as affiliated stores. By using the card-store correspondence table T1 and a card ID of a particular prepaid card, affiliated store ID(s) of one or more stores at which the particular prepaid card can be used can be obtained.

The store-mapping correspondence table T2 is a table indicating a correspondence between a store ID and a map element identifier (ID) of a map element corresponding to a store having the store ID. The store-mapping correspondence table T2 also indicates a map element description of each map element. The map element here is an element in a user-interactive retail space map that shows a location of each store in a retail space. In a specific implementation, each store ID is uniquely associated with a map element ID, and a map element of each map element ID can be described with the corresponding map element description in the store-mapping correspondence table T2. By using the store-mapping correspondence table T2 and a store ID of a store that is affiliated with a prepaid card, a map element ID and description of a corresponding map element can be obtained.

The merchandise table T3 is a table indicating a correspondence between a store ID and a merchandise ID of one or more kinds of merchandise that are registered for sale in a store having the store ID. The merchandise table T3 also indicates a price of each kind of merchandise and whether or not the merchandise is for promotion by using a promotion flag (may be abbreviated as “promo flag”), which may be expressed using a Boolean value. In a specific implementation, 0 of the promo flag indicates that the corresponding merchandise is not for promotion, and 1 of the promo flag indicates that the corresponding merchandise is for promotion. By using the store-mapping correspondence table T2 and a store ID of a store that is affiliated with a prepaid card, a merchandise ID, a price, and a promotion status of each of one or more kinds of merchandise that are registered for sale in the affiliated store can be obtained.

FIG. 5 is a block diagram illustrating an example of hardware components of a user-interactive digital signage apparatus 500 according to some embodiments. In some embodiments, the user-interactive digital signage apparatus 500 depicted in FIG. 5 corresponds to the digital signage apparatus 124 in FIG. 1 and/or the user-interactive digital signage apparatus 200 in FIG. 2. As shown in FIG. 5, the user-interactive digital signage apparatus 500 is configured with hardware components utilizing an ordinary computer, for instance, a control module 502, a communication I/F module 504, and an I/O device control module 506, which are connected through a bus line 516. In addition, the control module 502 comprises a CPU, a ROM, a RAM, and the like.

The control module 502 is a control module configured to control operations of the user-interactive digital signage apparatus 500. For example, the control module 502 controls the communication I/F module 504 to transmit data and process data received by the communication I/F module 504. In FIG. 5, the control module 502 is connected to a display module 508, a sound output module 510, a storage module 512, and a card reading module 514, and controls operations thereof.

The display module 508 is a display configured to display an image showing various kinds of information. In some embodiments, the display module 508 corresponds to the display module 204 in FIG. 2. The sound output module 510 outputs various kinds of sounds. In some embodiments, the sound output module 510 corresponds to the sound output module 206 in FIG. 2. The card reading module 514 is a reading module configured to read card information from a prepaid card presented by a user at the retail space. In some embodiments, the card reading module 514 corresponds to the card reading module 210 in FIG. 2.

The storage module 512 is a data storage module and may be implemented with a hardware device (HDD: hard disk drive) or an SSD (solid state drive) device and the like. The storage module 312 stores various kinds of information. In some embodiments, data stored in the storage module 512 may include same data as data stored in a storage module of a server apparatus, such as the storage module 312 in FIG. 3. That is, the storage module 512 may store data same as the card-store correspondence table T1, the store-mapping correspondence table T2, and the merchandise table T3 in FIG. 4. In such a case, the control module 502 may operate to import the store-mapping correspondence table T2, and the merchandise table T3 from a storage module of a server apparatus into the storage module 512.

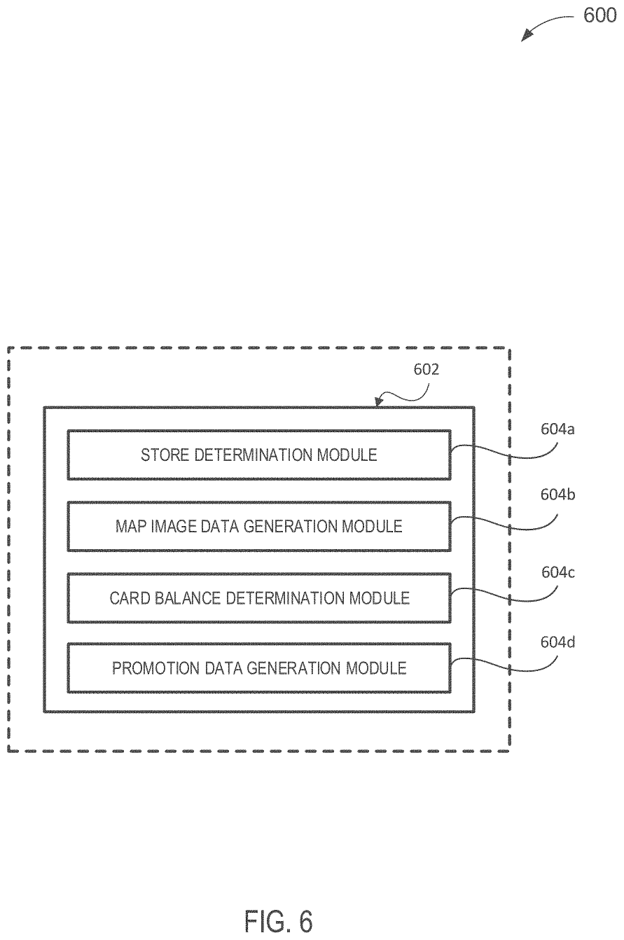

FIG. 6 is a block diagram illustrating an example 600 of functional components of a server apparatus according to some embodiments. In some embodiments, the example 600 of the functional components is achieved as a result of operations by a control module 602 of the server apparatus. In some embodiments, the control module 602 corresponds to the control module 302 in FIG. 3. As a result of operations of the control module 602, the control module 602 serves as a store determination module 604a, a map image data generation module 604b, a card balance determination module 604c, and a promotion image data generation module 604d.

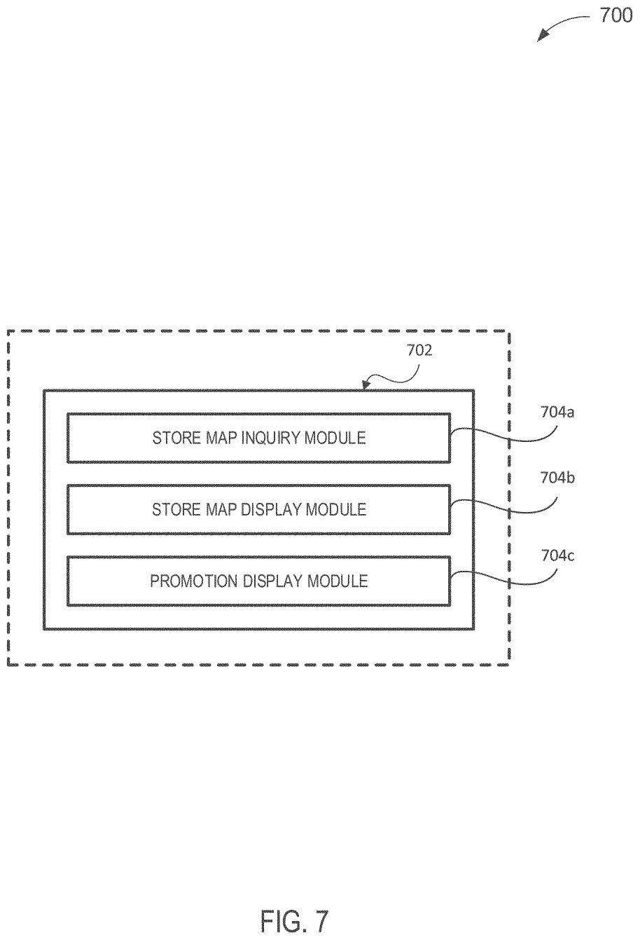

The store determination module 604a is a functional module configured to determine an affiliated store ID of each of one or more stores affiliated with a prepaid card based on card information of the prepaid card that is received from a user-interactive digital signage apparatus (e.g., a store map inquiry module 704a in FIG. 7). In some embodiments, the store determination module 604a determines a card category ID from a card ID included in the received card information, for example, based on a first few digit (e.g., 1-6 digit) number of a card number. Thereafter, the store determination module 604a refers to a card-store correspondence table, such as the card-store correspondence table T1 in FIG. 4, to determine the affiliated store ID of each of one or more stores from the card category ID. In some embodiments, the received card information may include a card category ID, and the store determination module 604a may determine the affiliated store ID of each of one or more stores from the card category ID included in the card information.

In some embodiments, when card information of a plurality of prepaid cards, e.g., first and second prepaid cards, is received, the store determination module 604a may determine: i) one or more affiliated stores that are affiliated with the first prepaid card, and not with the second prepaid card: ii) one or more affiliated stores that are affiliated with the second prepaid card, and not with the first prepaid card; and/or iii) one or more affiliated stores that are affiliated with both the first and second prepaid cards, among a plurality of stores in the retail space.

The map image data generation module 604b is a functional module configured to generate map image data for a map image of a retail space, based on the affiliated store ID of each of one or more affiliated stores. The map image data generation module 604b is further configured to operate to send the generated map image data to a user-interactive digital signage apparatus (e.g., a store map display module 704b in FIG. 7).

In some embodiments, when the affiliated store ID of each of one or more stores affiliated with a prepaid card is obtained by the store determination module 604a, the map image data generation module 604b determines a map element ID of a map element corresponding to each of the one or more affiliated stores, by referring to a store-mapping correspondence table, such as the store-mapping correspondence table T2 in FIG. 4. In such cases, the map image data includes information on the one or more affiliated stores that are affiliated with the prepaid card among a plurality of stores in the retail space. In some other embodiments, the map image data may include information on only a part, and not all, of the one or more affiliated stores that are affiliated with the prepaid card. For example, the part of the one or more affiliated stores may correspond to one or more stores having at least one kind of merchandise priced less than the balance of the prepaid card, which can be determined by the card balance determination module 604c, as described below.

In some embodiments, when card information of a plurality of prepaid cards, e.g., first and second prepaid cards, is received, the map image data may include information on i) one or more affiliated stores that are affiliated with the first prepaid card, and not with the second prepaid card: ii) one or more affiliated stores that are affiliated with the second prepaid card, and not with the first prepaid card; and/or iii) one or more affiliated stores that are affiliated with both the first and second prepaid cards, among a plurality of stores in the retail space.

The card balance determination module 604c is a functional module configured to obtain a balance of a prepaid card based on the received card information. In some embodiments, the card balance determination module 604c operates to send an inquiry to a server that manages payment processing of the prepaid card and obtains card balance data therefrom. The card balance determination module 604c is further configured to operate to send balance data indicating a balance of the prepaid card to a user-interactive digital signage apparatus (e.g., a store map display module 704b in FIG. 7).

In some embodiments, the card balance determination module 604c is also configured to determine a store ID of each of one or more affiliated stores that have merchandise that is priced less than the balance of the prepaid card. In such a case, the map image data generation module 604b may operate to send updated map image data including information on the one or more affiliated stores that have merchandise that is priced less than the balance of the prepaid card.

The promotion data generation module 604d is a functional module configured to generate promotion data indicating one or more kinds of promoted merchandise associated with at least one of the one or more affiliated stores. In some embodiments, the promotion data generation module 604d refers to a merchandise table, such as the merchandise table T3 in FIG. 4, to determine the one or more kinds of merchandise with a promo flag being asserted.

In some embodiments, the promotion data generation module 604d selects the one or more kinds of promoted merchandise from merchandise priced less than the balance of the prepaid card obtained by the card balance determination module 604c, among merchandise registered for sale in the one or more affiliated stores, by referring to the merchandise table. In some embodiments, the promotion data generation module 604d selects the one or more kinds of promoted merchandise from merchandise priced less than the balance of the prepaid card obtained by the card balance determination module 604c by a predetermined amount or less (e.g., $1.00), among merchandise registered for sale in the one or more affiliated stores.

In some embodiments, the promotion data generation module 604d may receive a designation (e.g., store ID) of one of the one or more affiliated stores from a user-interactive digital signage apparatus. In such a case, the promotion data generation module 604d may generate promotion data indicating one or more kinds of promoted merchandise associated with the designated one of the one or more affiliated stores, by referring to the merchandise table.

FIG. 7 is a block diagram illustrating an example 700 of functional components of a user-interactive digital signage apparatus according to some embodiments.

In some embodiments, the example 700 of the functional components is achieved as a result of operations by a control module 702 of the server user-interactive digital signage apparatus. In some embodiments, the control module 702 corresponds to the control module 502 in FIG. 5. As a result of operations of the control module 702, the control module 702 serves as a store map inquiry module 704a, a store map display module 704b, and a promotion display module 704c.

The store map inquiry module 704a is a functional module configured to inquire map image data including information on one or more affiliated stores that are affiliated with a prepaid card, to a server apparatus, such as the server apparatus 300 in FIG. 3. In some embodiments, in inquiring the map image data, the store map inquiry module 704a operates to send card information of the prepaid card. In a specific implementation, the card information includes a card ID of the prepaid card. In a specific implementation, the store map inquiry module 704a is configured to determine a card category ID from the card ID, and the card information includes both the card ID and the card category ID of the prepaid card.

In some embodiments, when a plurality of prepaid cards, e.g., first and second prepaid cards, is read, the store map inquiry module 704a obtains first card information from a first prepaid card and second card information from a second prepaid card, and operates to send the first card information and the second card information.

The store map display module 704b is a functional module configured to cause a user-interactive retail space map to be displayed on a display module of a user-interactive digital signage apparatus, such as the display module 204 in FIG. 2, based on map image data received from a server apparatus (e.g., the map image data generation module 604b in FIG. 6). The user-interactive retail space map includes one or more map elements corresponding to at least a part of the one or more affiliated stores, in an emphasized display manner with respect to one or more map elements corresponding to one or more non-affiliated stores in the retail space. Depending on a specific implementation of the embodiments, the “emphasized manner” may be achieved by highlighting, larger font size, flashing, bold font, use of different colors, to name a few.

In some embodiments, the store map display module 704b causes balance information, which includes a balance of the prepaid card, to be displayed on a display module of a user-interactive digital signage apparatus, such as the display module 204 in FIG. 2, based on balance data received from a server apparatus (e.g., the card balance determination module 604c in FIG. 6).

In some embodiments, the store map display module 704b detects a user touch operation on a map element in the user-interactive retail space map to select one of the one or more affiliated stores, and operates to send designation (e.g., store ID) of the selected one of the one or more affiliated stores to a server apparatus (e.g., the promotion data generation module 604d in FIG. 6).

The promotion display module 704c is a functional module configured to cause promotion information to be displayed on a display module of a user-interactive digital signage apparatus, such as the display module 204 in FIG. 2, based on promotion data received from a server apparatus (e.g., the promotion data generation module 604d in FIG. 6). In some embodiments, the promotion information includes an image of each of the promoted merchandise with a price thereof. In some embodiments, the promotion information is displayed so as to indicate an association with one of the one or more affiliated stores that has the promoted merchandise. In some embodiments, the promotion information is displayed in a display element overlaid on the user-interactive retail space map.

In some embodiments, the functional components of the user-interactive digital signage apparatus may further include functional modules that have the same or similar functions as those of the store determination module 604a, the map image data generation module 604b, the card balance determination module 604c, and the promotion image data generation module 604d in FIG. 6.

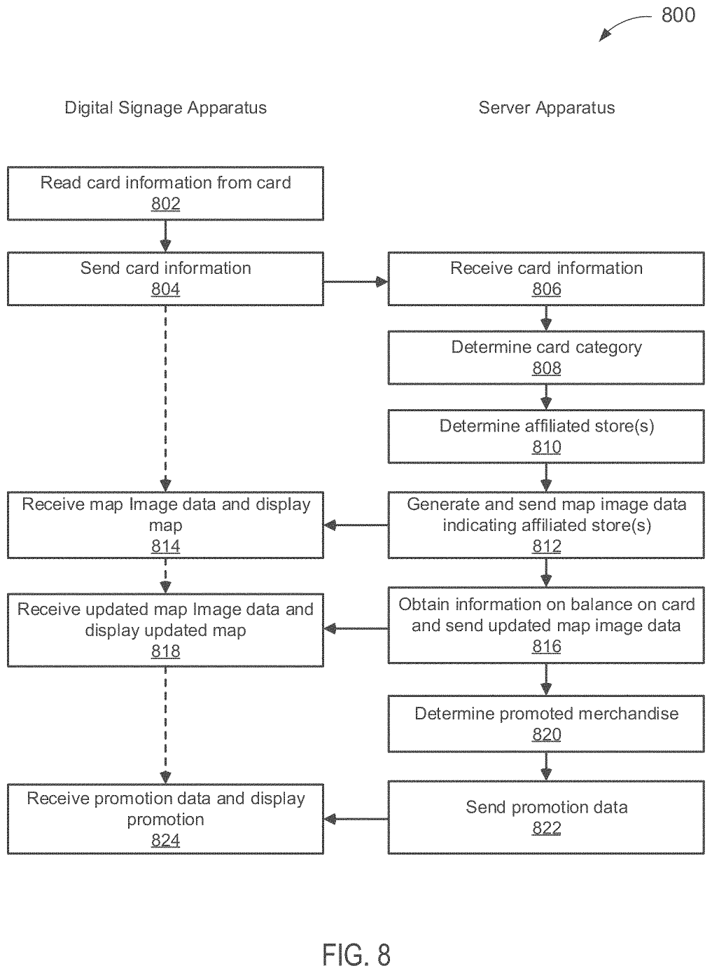

FIG. 8 is a flowchart 800 showing a process performed by a server apparatus and a user-interactive digital signage apparatus according to some embodiments. This flowchart illustrates steps organized in a fashion that is conducive to understanding. It should be recognized, however, that the steps can be reorganized for parallel execution, reordered, modified (changed, removed, or augmented), where circumstances permit. The steps shown in the flowchart 300 are carried out by a user-interactive digital signage apparatus such as the user-interactive digital signage apparatus 500 in FIG. 5 (e.g., for steps 802, 804, 814, 818, and 824) and a server apparatus such as the server apparatus 300 in FIG. 3 (e.g., for steps 806, 808, 810, 812, 816, 820, and 822).

In step 802, card information is read from a prepaid card presented by a user at a retail space. In some embodiments, the card information includes a card ID (e.g., card number) of the prepaid card. In some embodiments, a module, such as the card reading module 210 in FIG. 2 or the card reading module 514 in FIG. 5, reads the card information from the prepaid card.

In step 804, the card information obtained in step 802 is sent to the server apparatus. In some embodiments, a module, such as the store map inquiry module 704a in FIG. 7, controls a module, such as the communication interface module 504 in FIG. 5, to transmit the card information.

In step 806, the card information sent from the user-interactive digital signage apparatus is received by the server apparatus. In some embodiments, a module, such as the communication interface module 304 in FIG. 3, receives the card information.

In step 808, a card category of the prepaid card is determined. In some embodiments, a card category ID is determined based on a part of the card information, e.g., first four digits of a card number of the prepaid card, with reference to a card-store correspondence table, such as the card-store correspondence table T1 in FIG. 4. In some embodiments, a module, such as the store determination module 604a in FIG. 6, determines the card category ID.

In step 810, one or more stores affiliated with the prepaid card are determined. In some embodiments, a store ID of each of one or more affiliated stores is determined based on the part of the card information or the card category ID, with reference to the card-store correspondence table. In some embodiments, a module, such as the store determination module 604a in FIG. 6, determines the store ID of each of one or more affiliated stores.

In step 812, map image data indicating the one or more affiliated stores is generated and sent to the user-interactive digital signage apparatus. In some embodiments, a map element ID corresponding to the store ID of each of the one or more affiliated stores is determined based on the store ID determined in step 810, with reference to a store-mapping correspondence table, such as the store-mapping correspondence table T2 in FIG. 4. Then, the determined map element ID is included in the map image data. In some embodiments, a module, such as the map image data generation module 604b, generates the map image data and operates to transmit the generated map image data using a module, such as the communication interface module 304 in FIG. 3.

In step 814, the map image data is received by the user-interactive digital signage apparatus and a user-interactive retail space map corresponding to the map image data is displayed thereon. The user-interactive retail space map includes one or more map elements corresponding to at least a part of the one or more affiliated stores (i.e., the map element ID included in the map image data), in an emphasized display manner with respect to one or more map elements corresponding to one or more non-affiliated stores in the retail space. In some embodiments, a module such as the communication interface module 504 in FIG. 5, receives the map image data, and a module, such as the store map display module 704b in FIG. 7, operates to display the user-interactive retail space map on a display such as the display module 204 in FIG. 2.

In step 816, information on the balance of the prepaid card is obtained and updated map image data, which is generated based on the information on the balance, is sent to the user-interactive digital signage apparatus. In some embodiments, the information on the balance of the prepaid card is obtained from an external server. The updated map image data includes a map element ID of each of one or more of the affiliated stores having merchandise priced less than the balance of the prepaid card, which can be obtained from a merchandise table such as the merchandise table T3 in FIG. 4. The store ID of each of one or more of the affiliated stores having merchandise priced less than the balance of the prepaid card can be obtained from the store-mapping correspondence table. In some embodiments, a module, such as the card balance determination module 604c in FIG. 6 obtains the information on the balance of the prepaid card. In some embodiments, a module, such as the map image data generation module, generates the updated map image data and operates to transmit the updated map image data.

In step 818, the updated image data is received by the user-interactive digital signage apparatus and an updated user-interactive retail space map corresponding to the updated map image data is displayed thereon. In some embodiments, the updated user-interactive retail space map includes one or more map elements corresponding to one or more affiliated stores having merchandise priced less than the balance (i.e., the map element ID included in the updated map image data), in an emphasized display manner with respect to one or more map elements corresponding to one or more non-affiliated stores in the retail space. In some embodiments, module same as the modules employed in step 812, operates to perform step 818.

In step 820, promoted merchandise is determined based on the one or more affiliated stores determined in step 810. In some embodiments, to determine the promoted merchandise, one or more merchandise IDs of merchandise that corresponds to the affiliated store ID obtained in step 810 or the affiliated store ID obtained in step 816 and is designated as for promotion are determined with reference to the merchandise table. In some embodiments, to determine the promoted merchandise, one or more merchandise IDs of merchandise that corresponds to the affiliated store ID obtained in step 810 or step 816, is priced less than the balance, and is designated as for promotion are determined with reference to the merchandise table. In some embodiments, to determine the promoted merchandise, one or more merchandise IDs of merchandise that corresponds to the affiliated store ID obtained in step 810 or step 816, is priced less than the balance by a predetermined amount (e.g., $1.00), and is designated as for promotion are determined with reference to the merchandise table. In some embodiments, a module, such as the promotion data generation module 604d, determines the promoted merchandise.

In some embodiments, the promoted merchandise is determined in response to an indication of an affiliated store ID, which may be received from the user-interactive digital signage apparatus. In such a case, to determine the promoted merchandise, one or more merchandise IDs of merchandise that corresponds to the designated store ID, is priced less than the balance, and is designated as for promotion are determined.

In step 822, promotion data including information on the promoted merchandise determined in step 820 is sent to the user-interactive digital signage apparatus. In some embodiments, the promotion data includes the one or more merchandise IDs that are determined in step 820 and its associated information (e.g., image data and/or price of the corresponding merchandise). In some embodiments, a module, such as the promotion data generation module 604d, operates to send the promotion data.

In step 824, the promotion data is received by the user-interactive digital signage apparatus and promotion information corresponding to the received promotion data is displayed thereon. In some embodiments, the promotion information is displayed in a display element overlaid on the user-interactive retail space map or the updated user-interactive retail space map.

In a specific implementation, two or more prepaid cards may be presented by a user. In such a case, the steps 802-824 may be carried out with respect to each of the two or more prepaid cards. Depending on a processing speed and an interval of the presentation of the two or more prepaid cards, some of the steps 802-824, may be omitted for some of the two or more prepaid cards. In a specific implementation, as in FIG. 8, the processing is performed in the order of: i) generating a map showing stores affiliated with a prepaid card: ii) generating a map reflecting a balance of the prepaid card; and iii) generating promotion information, with sufficient timing lags in the processing for a user to recognize the different display views.

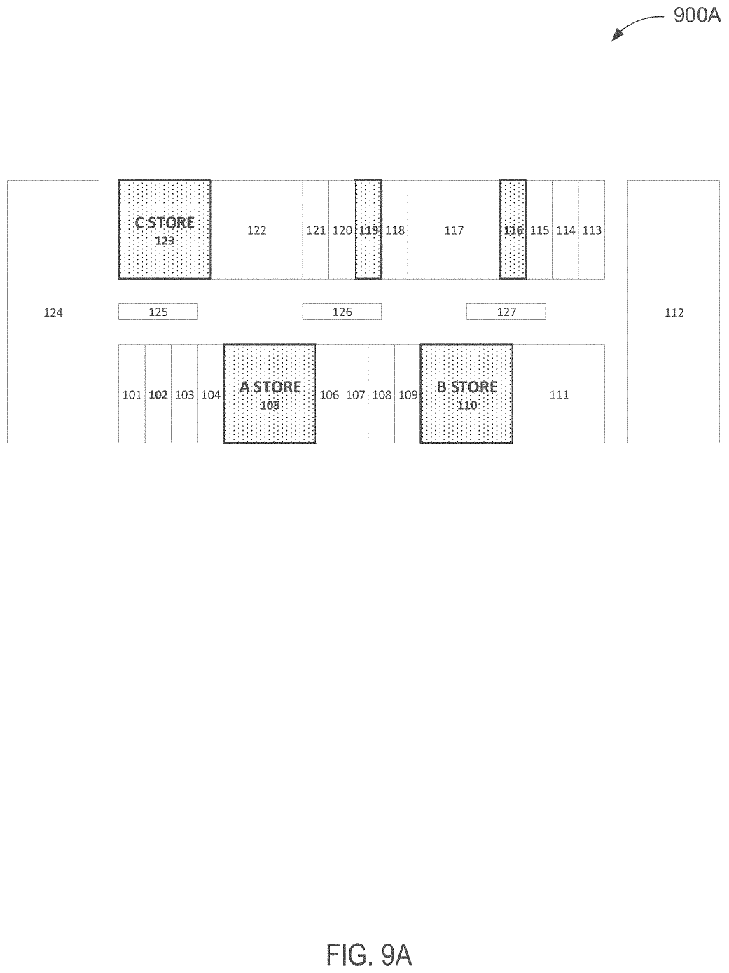

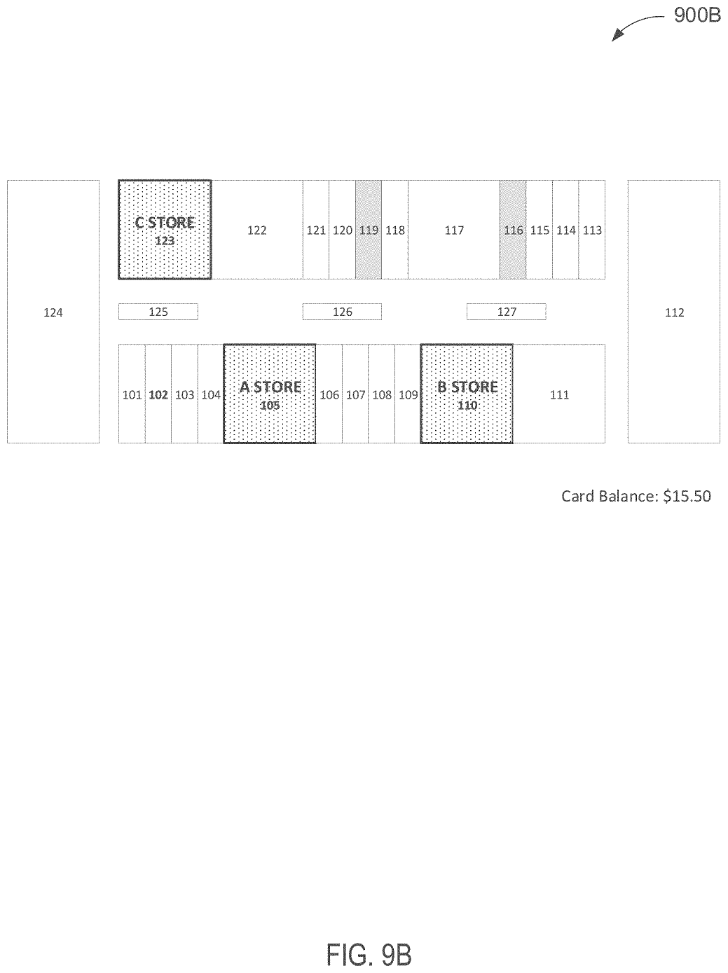

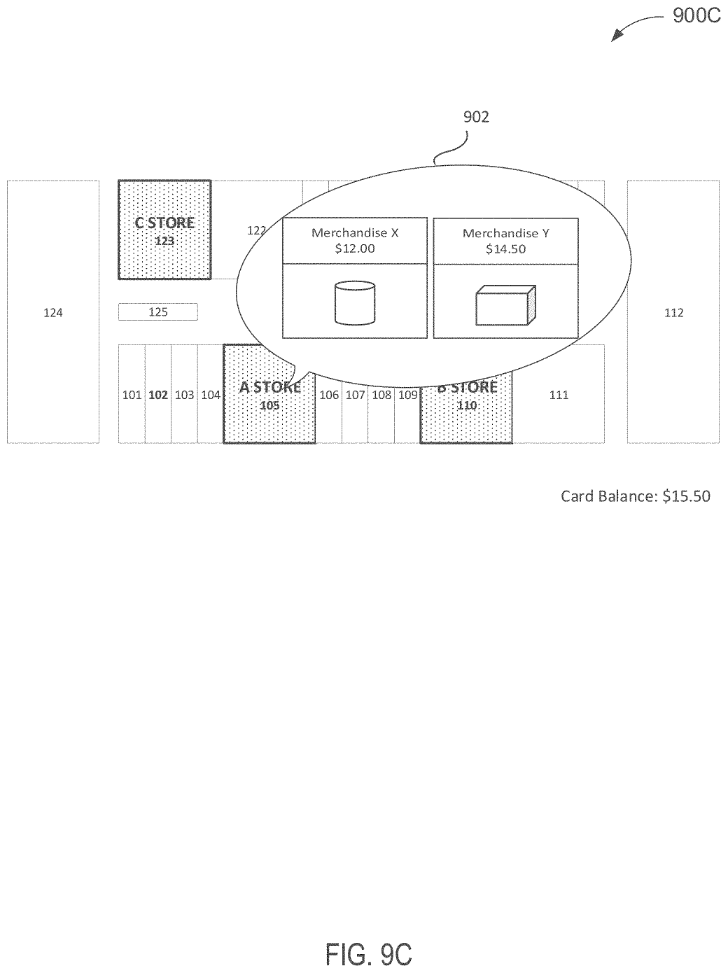

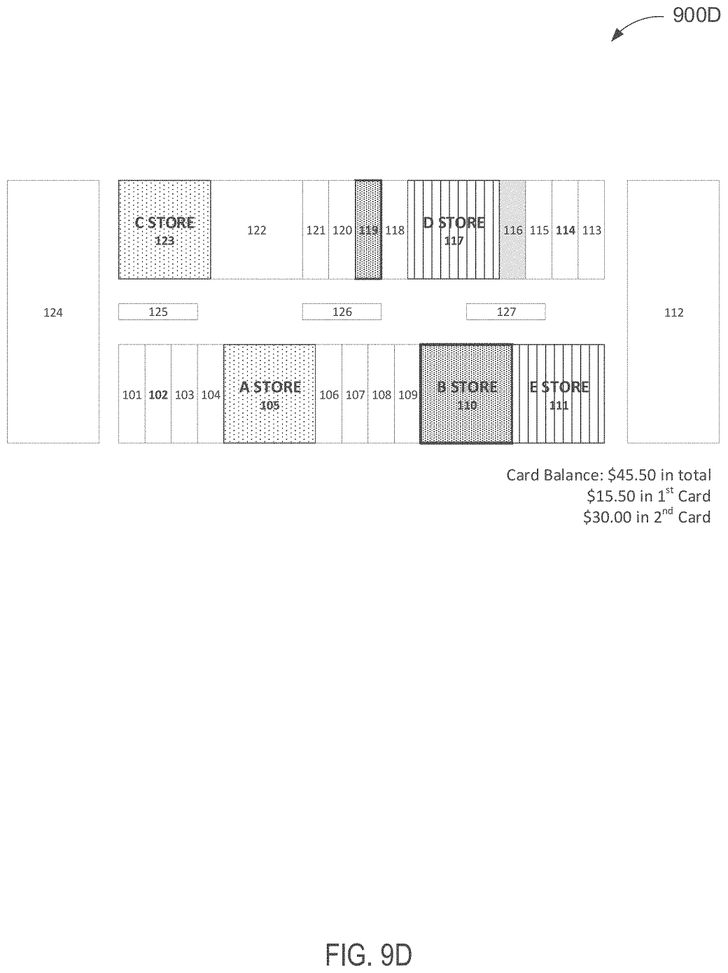

FIGS. 9A-9D illustrate an example of a user-interactive map displayed by a user-interactive digital signage apparatus according to some embodiments. In a specific implementation, the user-interactive maps in FIGS. 9A-9D may be displayed when a user presents, to the interactive digital signage apparatus, a first prepaid card having a balance of $15.50 and then a second prepaid card having a balance of $30.00.

FIG. 9A illustrates a user-interactive retail space map 900A displayed by the interactive digital signage apparatus. In a specific implementation, the user-interactive retail space map 900A may be displayed first after the first prepaid card is presented (read), and before information on a balance of the first prepaid card is obtained by the interactive digital signage apparatus. The user-interactive retail space map 900A is a floor map of a retail space (e.g., shopping mall), and each store in the retail space is depicted using a display element of a rectangular shape, with a store number (e.g., store ID). Some (i.e., stores 105, 110, 116, 119, and 123) of the stores in the floor map that are affiliated with the first prepaid card are displayed in an emphasized display manner. More specifically, the display elements of the stores affiliated with the first prepaid card are displayed with a store name of a larger and bold font and a bold contour line, and with hatching. Depending on a specific implementation, any applicable methods can be used to emphasize the affiliated stores.

FIG. 9B illustrates a user-interactive retail space map 900B displayed by the interactive digital signage apparatus after the user-interactive retail space map 900A in FIG. 9A. In a specific implementation, the user-interactive retail space map 900B may be displayed upon the information on the balance of the first prepaid card being obtained by the interactive digital signage apparatus. In user-interactive retail space map 900B, a part of the affiliated stores that have merchandise priced less than the balance of the first prepaid card remains displayed in the emphasized manner. Another part of the affiliated stores that do not have merchandise priced than the balance of the first prepaid card is no longer displayed in the emphasized manner and grayed out. In a specific implementation, a user touch operation on the grayed out display element may be disabled, whereas the user touch operation on non-grayed-out display elements may be enabled. In addition, the user-interactive retail space map 900B includes an indication of the balance of the first prepaid card.

FIG. 9C illustrates a user-interactive retail space map 900C displayed by the interactive digital signage apparatus after the user-interactive retail space map 900B in FIG. 9B. In a specific implementation, the user-interactive retail space map 900C may be displayed after a user touch operation on a display element corresponding to the store 105. The user-interactive retail space map 900C includes a display element overlaid thereon, which includes an image of prompted merchandise X priced at $12.00 and an image of prompted merchandise Y priced at $14.50, which are less than the balance of the first prepaid card.

FIG. 9D illustrates a user-interactive retail space map 900D displayed by the interactive digital signage apparatus after the user-interactive retail space map 900C in FIG. 9C. In a specific implementation, the user-interactive retail space map 900D may be displayed after the second prepaid card is presented (read). Some (i.e., stores 110 and 119) of the stores in the floor map that are affiliated with both the first and second prepaid cards are displayed in an emphasized display manner. More specifically, the display elements of the stores affiliated with the first and second prepaid cards are displayed with a store name of a larger and bold font and a bold contour line, and with hatching. Depending on a specific implementation, display elements of the stores (i.e., stores 105, 116, and 123) affiliated with the first prepaid card and not with the second prepaid card may be displayed in a less emphasized manner than the display elements of the stores affiliated with the first and second prepaid cards, and a more emphasized manner than display elements of stores affiliated with neither the first nor second prepaid cards. The same is true for the display elements of the stores (i.e., stores 111 and 117) affiliated with the second prepaid card, and not with the first prepaid card. The display element of the store 116 remains grayed out as the store 116 does not have merchandise priced less than the balance of the first prepaid card.

In addition, the user-interactive retail space map 900D includes an indication of the total balance of the first and second prepaid cards, the balance of the first prepaid card, and the balance of the second prepaid card. It is noted here that the display element of the store 119 was grayed out in the user-interactive retail space map 900B as the store 119 does not have merchandise priced less than the balance of the first prepaid card. However, as the store 119 has merchandise priced less than the total balance of the first and second prepaid cards, the display element of the store 119 returns to be displayed in the emphasized display manner.

Depending on the specific categories of the first and second prepaid cards, there may not be any store that is affiliated with both the first and second prepaid cards. In such a case, display elements of stores affiliated with the first prepaid card, and not with the second prepaid card may be displayed in a first emphasized manner, and display elements of stores affiliated with the second prepaid card, and not with the first prepaid card may be displayed in a second emphasized manner different from the first emphasized manner. Alternatively, no display elements of stores may be displayed in an emphasized manner, and instead a notification that no store is affiliated with both the first and second prepaid card may be displayed or announced (e.g., by sounds and/or alarm).

The techniques described herein can be implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The various features and processes described above may be used independently of one another, or may be combined in various ways. All possible combinations and sub-combinations are intended to fall within the scope of this disclosure. In addition, certain method or process steps may be omitted in some implementations. The methods and processes described herein are also not limited to any particular sequence, and the steps or states relating thereto can be performed in other sequences that are appropriate. For example, described steps or states may be performed in an order other than that specifically disclosed, or multiple steps or states may be combined in a single step or state. The example steps or states may be performed in serial, in parallel, or in some other manner. Steps or states may be added to or removed from the disclosed example embodiments. The example systems and components described herein may be configured differently than described. For example, elements may be added to, removed from, or rearranged compared to the disclosed example embodiments.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A user-interactive digital signage apparatus comprising:
a signage housing formed to be placeable at a retail space;
a touch panel display mounted in the signage housing;
a card reader mounted on the signage housing and configured to read card information from a prepaid card presented by a user at the retail space; and
a controller configured to:
obtain map image data for a map image of the retail space using the card information, the map image data including information on one or more affiliated stores that are affiliated with the prepaid card among a plurality of stores in the retail space; and
control the touch panel display to display a user-interactive retail space map including one or more map elements corresponding to at least a part of the one or more affiliated stores, in an emphasized display manner with respect to one or more map elements corresponding to one or more non-affiliated stores in the retail space.

2. The user-interactive digital signage apparatus according to claim 1, further comprising:
a communication interface, wherein
the controller is further configured to control the communication interface to transmit the card information to a server and then receive the map image data from the server.

3. The user-interactive digital signage apparatus according to claim 2, wherein
the communication interface is configured to receive balance data indicating a balance of the prepaid card, and
the controller is further configured to control the touch panel display to display balance information corresponding to the balance data.

4. The user-interactive digital signage apparatus according to claim 1, wherein
a balance of the prepaid card is obtainable from the card information read by the card reader, and
the at least a part of the one or more affiliated stores is a part of the one or more affiliated stores that are affiliated with the prepaid card, each of the part of the one or more affiliated stores having at least one kind of merchandise priced less than the balance of the prepaid card.

5. The user-interactive digital signage apparatus according to claim 1, wherein
the controller is further configured to:
obtain promotion data indicating one or more kinds of promoted merchandise associated with at least one of the one or more affiliated stores; and
control the touch panel display to display promotion information corresponding to the promotion data.

6. The user-interactive digital signage apparatus according to claim 5, wherein
the controller is further configured to:
detect a user touch operation on a map element in the user-interactive retail space map to select one of the one or more affiliated stores, wherein
the promotion data indicates one or more kinds of promoted merchandise associated with the selected one of the one or more affiliated stores.

7. The user-interactive digital signage apparatus according to claim 6, wherein
the controller is further configured to display the promotion information in a display element overlaid on the user-interactive retail space map.

8. The user-interactive digital signage apparatus according to claim 5, wherein
a balance of the prepaid card is obtainable from the card information read by the card reader, and
the one or more kinds of promoted merchandise are selected from merchandise that is priced less than the balance, among merchandise registered for sale in the one or more affiliated stores.

9. The user-interactive digital signage apparatus according to claim 5, wherein
a balance of the prepaid card is obtainable from the card information read by the card reader, and
the one or more kinds of promoted merchandise are selected from merchandise that is priced less than the balance by a predetermined amount or less, among merchandise registered for sale in the one or more affiliated stores.

10. The user-interactive digital signage apparatus according to claim 1, wherein the card reader is configured to electro-magnetically read the card information from the prepaid card.

11. A user-interactive digital signage apparatus comprising:
a signage housing formed to be placeable at a retail space;
a touch panel display mounted in the signage housing;
a card reader mounted on the signage housing and configured to read card information from a prepaid card presented by a user at the retail space; and
a controller configured to:
obtain first card information from a first prepaid card read by the card reader and second card information from a second prepaid card read by the card reader;
obtain map image data for a map image of the retail space using the first and second card information, the map image data including information on one or more affiliated stores that are affiliated with the first and second prepaid cards among a plurality of stores in the retail space; and
control the touch panel display to display a user-interactive retail space map including one or more map elements corresponding to at least a part of the one or more affiliated stores, in an emphasized display manner with respect to one or more map elements corresponding to one or more non-affiliated stores in the retail space.

12. The user-interactive digital signage apparatus according to claim 11, further comprising:
a communication interface, wherein
the controller is further configured to control the communication interface to transmit the first and second card information to a server and then receive the map image data from the server.

13. The user-interactive digital signage apparatus according to claim 12, wherein
the communication interface is configured to receive balance data indicating a sum of a balance of the first and second prepaid cards, and
the controller is further configured to control the touch panel display to display balance information corresponding to the balance data.

14. The user-interactive digital signage apparatus according to claim 11, wherein
a balance of the first prepaid card is obtainable from the first card information, and a balance of the second prepaid card is obtainable from the second card information, and
the at least a part of the one or more affiliated stores is a part of the one or more affiliated stores that are affiliated with the first and second prepaid cards, each of the part of the one or more affiliated stores having at least one kind of merchandise priced less than a sum of the balance of the first prepaid card and the second prepaid card.

15. The user-interactive digital signage apparatus according to claim 11, wherein
the controller is further configured to:
obtain promotion data indicating one or more kinds of promoted merchandise associated with at least one of the one or more affiliated stores; and
control the touch panel display to display promotion information corresponding to the promotion data.

16. The user-interactive digital signage apparatus according to claim 15, wherein
the controller is further configured to:
detect a user touch operation on a map element in the user-interactive retail space map to select one of the one or more affiliated stores, wherein
the promotion data indicates one or more kinds of promoted merchandise associated with the selected one of the one or more affiliated stores.

17. The user-interactive digital signage apparatus according to claim 16, wherein
the controller is further configured to display the promotion information in a display element overlaid on the user-interactive retail space map.

18. The user-interactive digital signage apparatus according to claim 15, wherein
a balance of the first prepaid card is obtainable from the first card information, and a balance of the second prepaid card is obtainable from the second card information, and
the one or more kinds of promoted merchandise are selected from merchandise that is priced less than a sum of the balance of the first prepaid card and the balance of the second prepaid card, among merchandise registered for sale in the one or more affiliated stores.

19. The user-interactive digital signage apparatus according to claim 15, wherein
a balance of the first prepaid card is obtainable from the first card information, and a balance of the second prepaid card is obtainable from the second card information, and
the one or more kinds of promoted merchandise are selected from merchandise that is priced less than a sum of the balance of the first prepaid card and the balance of the second prepaid card by a predetermined amount or less, among merchandise registered for sale in the one or more affiliated stores.

20. The user-interactive digital signage apparatus according to claim 11, wherein the card reader is configured to electro-magnetically read the card information from the prepaid card.
